(19) United States
(12) Patent Application Publication
(10) Pub. No.: US 2017/0320757 A1
(43) Pub. Date: Nov. 9, 2017

(54) Rod-Shaped Electrolysis Device

(71) Applicant: Heinz Römer, Monheim (DE)

(72) Inventor: Heinz Römer, Monheim (DE)

(21) Appl. No.: 15/522,835

(22) PCT Filed: Oct. 29, 2015
(86) PCT No.: PCT/EP2015/075123

§ 371 Date: May 25, 2017

(30) Foreign Application Priority Data
Oct. 30, 2014 (DE) 10 2014 015 935.3

(51) Int. Cl. C02F 1/461; C02F 1/467

(52) U.S. Cl. CPC C02F 1/46109; C02F 1/4674; C02F 2209/005; C02F 2201/4615; C02F 2201/4614; C02F 2201/008; C02F 2201/004; C02F 2201/003; C02F 2001/46171; C02F 2303/04; C02F 2201/46135

(57) ABSTRACT

A rod-shaped electrolysis device having an electrically conductive housing, wherein in the housing, a receiving space for at least one voltage source and an electronic control unit is embodied which is separated from an electrode space formed in the housing in a liquid-tight manner, and wherein an electrode extends within the electrode space, and wherein in the housing, at least one opening is formed in the region of the electrode space. The electrolysis device is characterized in that the housing comprises a receiving socket which is electrically connected both with the housing and the electrode. Via the receiving socket, the residual voltage of a voltage source and also the charging of a rechargeable voltage source may be measured. Furthermore, a data memory may be read out via the receiving socket.

### CROSS REFERENCE TO RELATED APPLICATIONS

This application is the U.S. national stage of International Application No. PCT/EP2015/075123, filed on 2015 Oct. 29. The international application claims the priority of DE 102014015935.3 filed on 2014 Oct. 30; all applications are incorporated by reference herein in their entirety.

### BACKGROUND

The invention relates to a rod-shaped electrolysis device having an electrically conductive housing, wherein in the housing, a receiving space for at least one voltage source and an electronic control unit is embodied, the space being separated from an electrode space formed in the housing in a liquid-tight manner, and an electrode extending within the electrode space, and at least one opening being formed in the housing in the region of the electrode space.

Such electrolysis devices are known from prior art. They are known, for example, from German patent DE 10 2009 011 108 B4, DE 10 2010 044 315 B4, U.S. Pat. No. 6,261,464 B1 and U.S. Pat. No. 6,524,475 B1. The mentioned prior art relates to transportable electrolysis devices, for example in the form of a ball point pen or a fountain pen, which may be easily carried along thanks to their small dimensions and may thus also be employed in non-urban areas far away from civilisation, for example in the Siberian steppe or African savannas. Such electrolysis devices are used for the disinfection of water, so that existing raw water may be disinfected and subsequently drunk without any risks of infections being involved. In the course of the electrolysis process, sodium hypochlorite is formed which shows its disinfecting effect. Normally, the sodium chloride present in water by nature is sufficient to generate an amount of sodium hypochlorite from water and its dissociation products OH⁻ and H⁺ that is sufficient for the disinfection of the raw water. With respect to the reaction mechanism, reference is made to prior art in which the generation of sodium hypochlorite in raw water by means of two electrodes between which there is an electric potential difference, is illustrated.

The current Ebola epidemy (2014) in particular powerfully demonstrates the need for humans with modest financial means to also be able to have access to germ-free drinking water or water for washing their bodies, in particular their hands, or utensils for food consumption, such as cutlery or cookware, in order to curb such epidemy. Chlorination by adding chlorine gas, chlorine dioxide or sodium hypochlorite for disinfecting water is, due to the required provision of the mentioned chemicals, more expensive than disinfection by means of sodium hypochlorite generated during an electrolysis process, in the course of which normally no separate chemicals are required due to the natural NaCl content of the water, and in particular, there is no need to continuously supply these chemicals.

### SUMMARY

The invention relates to a rod-shaped electrolysis device 1 having an electrically conductive housing 2, wherein in the housing 2, a receiving space 3 for at least one voltage source 4 and an electronic control unit 5 is embodied which is separated from an electrode space 6 formed in the housing 2 in a liquid-tight manner, and wherein an electrode 7 extends within the electrode space 6, and wherein in the housing 2, at least one opening 13 is formed in the region of the electrode space 6. The electrolysis device 1 is characterized in that the housing 2 comprises a receiving socket 10 which is electrically connected both with the housing 2 and the electrode 7. Via the receiving socket 10, the residual voltage of a voltage source 4 and also the charging of a rechargeable voltage source 4 may be measured. Furthermore, a data memory may be read out via the receiving socket 10.

### DETAILED DESCRIPTION

It is the object of the present invention to provide a further improved embodiment of such transportable electrolysis devices which include further improvements compared to the electrolysis devices known from prior art.

To achieve this object, the intention is to provide the housing with a receiving socket which is electrically connected both to the housing and the electrode. Further advantageous embodiments of the invention can be taken from the subclaims.

By means of the receiving socket, the electrolysis device according to the invention may be connected to a corresponding charge station which in turn comprises a corresponding receiving socket or charging cable with a plug contact. Equally, the residual voltage of the voltage source(s) disposed in the receiving space may be measured via the receiving socket. The receiving socket of the electrolysis device is electrically connected on the one hand to the housing and on the other hand to the electrode in the electrode space. Due to its electric conductivity, the housing functions as a first electrode in the region of the electrode space, and the electrode in the electrode space functions as a second electrode, an electric potential difference, i.e. an electric voltage, being applied between them by means of voltage sources to be arranged within the receiving space of the housing. By the electrical connection of the receiving socket on the one hand with the electrode in the electrode space and on the other hand with the housing, an accumulator arranged within the receiving space may be charged.

To avoid corrosion of the contacts present in the receiving socket, these preferably consist of stainless special steel or a noble metal coating. The housing also preferably consists of stainless special steel.

The housing may comprise several openings in the region of the electrode space which are arranged distributed on the housing along its periphery and/or in the extension direction of the electrode space.

The electrolysis device according to the invention may be transported like a pen due to its compact design, for example in a vest or upper arm pocket. The simple structural design permits an inexpensive manufacture of the electrolysis device according to the invention, such that they may be provided in high numbers at comparatively low costs, for example in developing countries or in regions where inundations occurred and the supply of the population concerned with drinking water or water for washing the body, in particular the hands, or utensils for food consumption, such as cutlery or cookware, is at risk.

The electrolysis device may be embodied such that the electronic control unit comprises a data memory and the receiving socket is electrically connected to the data memory in such a manner that the data memory may be read out via the receiving socket, operational data of the electrolysis device being stored in the data memory. Operational data are here understood as any data which document the operation of the device, such as the activation and deactivation times, the activation duration, the charging condition of the voltage source during activation and deactivation, the degree of shock detected via the motion sensor, the conductance calculated by the microprocessor, error messages generated by the microprocessor, data identifying the owner of an electrolysis device, et cetera. The electronic control unit may be furthermore embodied to be programmable. However, a programme for the operation of the electrolysis device may also be stored on the data memory.

In a further development of the invention, it may be intended to arrange the receiving socket at a front face of the housing, whereby the electrolysis device according to the invention may be placed onto a corresponding receiving socket of a charge station in an upright position. In this embodiment, constructive simplicity is maintained despite the integration of a receiving socket into the electrolysis device. The charge station, too, can be correspondingly easily realised, since the electrolysis device only has to be placed onto the corresponding receiving socket of the charging unit.

The electrode in the electrode space is, in a preferred embodiment of the electrolysis device according to the invention, designed in the shape of a rod and has a hemispherical front face. The hemispherical front face first causes an enlargement of the electrode surface, such that, at a given intensity of current per time unit, a larger amount of the disinfecting sodium hypochlorite is generated. Furthermore, any inhomogeneities of the electric field, that means a locally higher density of electric field lines which occurs at the edges of a flat front face of a cylindrical electrode, are avoided, such that the electrode is more evenly stressed in view, for example, of a possibly existing coating or an occurring furring, thus increasing its efficiency and service life.

Furthermore, a sealing body may be provided and arranged within the electrode space between the housing and the electrode, the sealing body extending across a portion of the receiving space and/or the electrode space. By means of a sealing body, the receiving space may be easily separated from the electrode space in a liquid-tight manner, separation being simply realised by inserting the sealing body into the housing. Such a sealing body may be exchanged particularly quickly and inexpensively if any leakage is expected or has already occurred. In case of a sealing body extending within the electrode space, the active region of the electrode is limited to the region located beyond the insulating body because only there, field lines may be formed between the housing and the electrode in the electrode space.

In a further embodiment of the electrolysis device according to the invention, at least one lamp may be provided and disposed in the receiving space, and at least one light conductor may extend from the receiving space into the electrode space, the light conductor being arranged at one end within the receiving space in such a manner that the light emitted from the lamp enters the light conductor. In this embodiment, at least one lamp is provided in the receiving space, the light emitted from it being conducted into the electrode space via light conductors. By this measure, an occurring electrolysis process may be made visible by the naked eye, since during the electrolysis process, hydrogen gas (H²) is always formed and exits from the at least one opening of the housing in the region of the electrode space, and the light of the lamp entering the electrode space is reflected at the hydrogen bubbles. The lamps may be light-emitting diodes, which is preferred due to the low power consumption of correspondingly selected light-emitting diodes. The lamps may emit multicoloured light and indicate various operational states of the electrolysis device according to the invention. It may be intended, for example, that green light indicates a sufficient charging condition of the voltage source, yellow light indicates a low charging condition of the voltage source, and red light indicates a charging condition of the voltage source that is no longer sufficient for the electrolysis process. The light conductor may be at least a glass fibre or at least a glass fibre bundle which are arranged within the receiving space at one end such that light emitted from the lamp enters the glass fibre or the glass fibre bundle. The light conductor may furthermore be guided at the other end into the electrode space to the at least one opening, such that the light from the light conductor exits in the region of the electrode space in direct proximity to the opening of the housing, which means exactly where the hydrogen bubbles find their way to the opening. Thereby, a progressing electrolysis process may be observed with the naked eye even at a relatively low luminous power. The light conductor may extend through the sealing body, a corresponding channel being embodied in the sealing body, such that the insulating body or sealing body simultaneously forms a protective case for the light conductor, and any damage to it is avoided.

In a further embodiment, it may be intended that the electronic control unit includes a time switch, a magnetic field sensor being present and the time switch being activated by an external magnetic field, and/or wherein a motion sensor is provided and the time switch is activated by a shock of the housing detected by the motion sensor. This embodiment has the particular advantage that the circuitry (electronic control unit) is completely integrated in the housing and is not operated via operational controls, such as buttons, projecting from the housing. This results in a number of advantages. First of all, the housing does not have to include any particular openings for operational controls, which would render the manufacture of the housing more complicated. Secondly, just by such openings for operational controls, dust and other dirt would penetrate into the interior of the housing and, in the course of time, possibly affect the electronic control unit or lead to an undesired absorption or diffusion of the light emitted by the at least one lamp—if provided. Thirdly, the assembly and disassembly of the individual components of the electrolysis device according to the invention, that means the housing, the electronic control unit, the electrode, the receiving socket, and optionally the sealing body, are particularly easy if operational controls projecting from the housing are omitted. It may be furthermore intended that a term as a multiple of a time interval may be determined by repeatedly approaching an external magnetic field to the housing and/or by a repeated shock of the housing, the multiple being equal to the number of repetitions. In this embodiment, a time switch is integrated in the electronic control unit and is operated by means of an external magnetic field or a shock of the housing. The time interval is predetermined by the electronic control unit and is the shortest term, in which case the multiple is equal to 1. Electrolysis subsequently takes place during the term resulting from the time interval and the multiple. This permits to correlate the term with the amount of water to be disinfected. This may be done, for example, such that for a sufficient disinfection of n litres of raw water, n repetitions are required (approaching an external magnetic field or a shock of the housing).

It may be furthermore provided for the electronic control unit to comprise a current and voltage regulator by means of which the electric voltage between the electrode and the housing and the intensity of current flowing between them may be adjusted to different values. Preferably, the voltage is set to 5V or 6.5V with a precision of ±2%, and the intensity of current is set to a value between 40 mA and 460 mA at 5V, or 40 mA and 350 mA at 6.5V.

Here, it may be provided for the current and voltage regulator to comprise a MOSFET (Metal Oxide Field Effect Transistor) by means of which the intensity of current between the housing and the electrode can be adjusted, the adjustment preferably being effected with a precision of ±10%. The MOSFET may comprise a closed-circuit current of 5 μA and an internal resistance of 0.060. It may be additionally switched off in a voltage overload-proof manner, in a short-circuit-proof manner and in case of overheating.

It may be furthermore provided for the electronic control unit to comprise a microprocessor which performs a calculation of the conductance and adjusts, depending on the calculated conductance, the voltage and the intensity of current between the housing and the electrode. In the process, at a certain voltage, the intensity of current between the electrode and the housing is measured by means of a precision resistor. From the pair of variates (voltage U, intensity of current I), the microprocessor then calculates the conductance G of the water into which the electrode space is immersed (G=1/R=I/U; R ohmic resistance).

By means of the calculated conductance, the conductivity of the raw water to be disinfected may be established, and the concentration of salt may thus be gathered from this. With a low salt concentration, the electronic control unit may predetermine a longer time interval at the same intensity of current as compared to a higher salt concentration, as in this case, with the same amount of raw water, more time is required until a sufficient amount of sodium hypochlorite is generated. As an alternative, with the same time interval at a lower salt concentration, a higher intensity of current may be predetermined as compared to a higher salt concentration. To this end, a table of values (time interval|intensity of current|conductance) may be stored in the data memory which is accessed by the electronic control unit.

The mentioned microprocessor may even serve as a time switch—together with corresponding sensors (magnetic field sensor, motion sensor).

The microprocessor can be a 16-bit controller with 8 kB ROM (read-only memory), 1 kB RAM (random access memory) and a clock frequency of 8 MHz, which requires only 640 μA in operation.

In one embodiment of the electrolysis device according to the invention, the latter comprises an acoustic signal transmitter which points out a malfunction detected by the electronic control unit by means of an acoustic error message, for example in the form of a simple tone having a frequency of 4 KHz and a volume of 73 dB at a distance of 10 cm. The error message may be correlated with the operating states optically indicated by the lamps (see above), so that acoustic signals are generated in addition to optical signals. The acoustic signal transmitter may be triggered by the microprocessor.

The invention will be further illustrated more in detail with reference to the FIGURES.

### BRIEF DESCRIPTION OF THE DRAWINGS

In the drawings:

FIG. 1 shows a cross-sectional view of a first embodiment of the electrolysis device according to the invention.

### DETAILED DESCRIPTION OF THE PREFERRED EMBODIMENTS

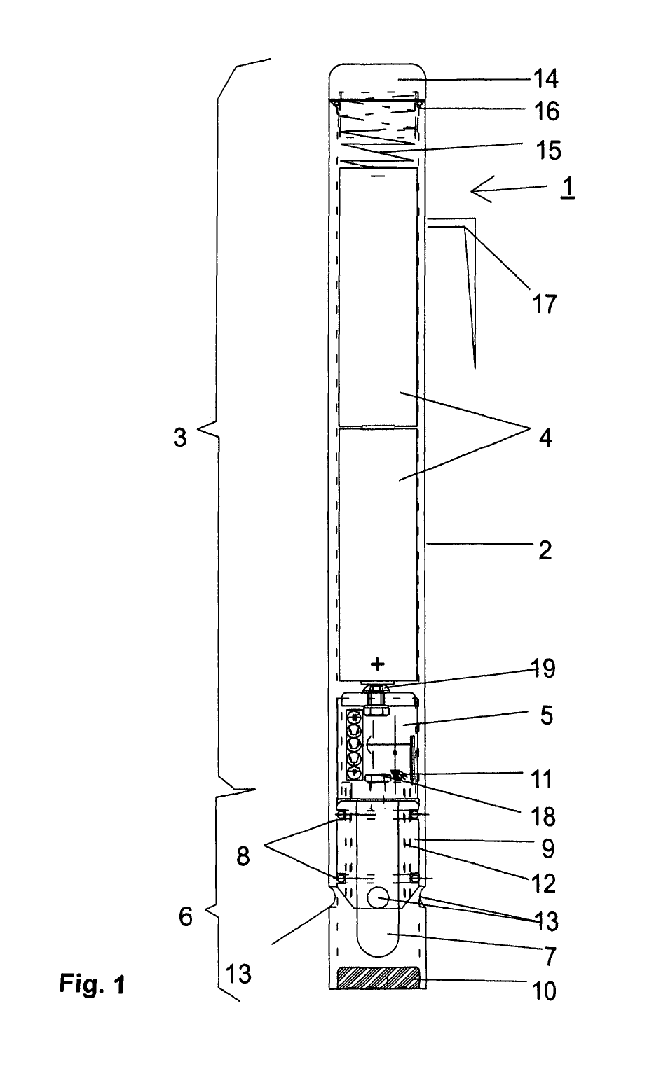

FIG. 1 shows a cross-sectional view of a first embodiment of an electrolysis device 1 according to the invention with a rod-shaped housing 2. Within the housing 2, a receiving space 3 for at least one voltage source 4 and the electronic control unit 5 and an electrode space 6 are embodied. An electrode 7 is arranged within the electrode space 6, the electrode having a hemispherical front face. The electrode space 6 is separated from the receiving space 3 by a sealing body 9 in a liquid-tight manner, the electrode 7 extending through the sealing body 9. The circumferential surface of the sealing body 9 comprises two indentations extending across its complete periphery, one sealing ring 8 each being arranged therein. At a front face of the housing 2, a receiving socket 10 is arranged via which the charging of the voltage source 4 arranged within the receiving space 3, if it is an accumulator, the measurement of the residual voltage of the voltage source 4, and—since the electronic control unit 5 comprises an electronic data memory—the reading out of the data memory are possible. Furthermore, a light-emitting diode 11 is arranged within the receiving space 3 which in this case is integrated in the electronic control unit 5. A plurality of light conductors 12 extend from the receiving space 3 into the electrode space, such that the progression of electrolysis may be observed with the naked eye, since the light of the light-emitting diode 11 is conducted into the electrode space 6 via the light conductors 12 and is reflected there at the hydrogen bubbles formed during the electrolysis process. In the region of the electrode space 6, the housing 2 comprises a plurality of openings 13 which, in this embodiment, are arranged distributed along the periphery of the housing 2. The front face of the housing 2 facing away from the receiving socket 10 is closed with a screw cap 14. The screw cap 14 comprises a spring 15 by means of which the contact of the voltage source 4 is pressed against the contact of the electronic control unit 5 to thus permit a reliable contact even in case of shocks of the electrolysis device 1. Between the screw cap 14 and the front face of the housing 2 facing to it, a sealing ring 16 is arranged, such that no water can penetrate into the receiving space 3. Furthermore, a bow 17 is fixed to the housing 2 by means of which the electrolysis device 1 may be fixed to a water container, for example.

The electronic control unit 5 comprises a time switch which may be activated by approaching an external magnetic field to the housing 2 or by mechanical shocks of the housing 2.

The electronic control unit 5 is connected to the electrode 7 via a screw 18 whereby an electric connection between the electronic control unit 5 and the electrode 7 is established. Contacting of the voltage source 4 arranged within the receiving space 3 is also done by means of a screw 19. This embodiment of the electrolysis device 1 according to the invention was intentionally selected such that the manufacture of the electrolysis device 1 is as simple and thus inexpensive as possible.

### LIST OF REFERENCE NUMERALS

1 electrolysis device
2 housing
3 receiving space
4 voltage source
5 electronic control unit
6 electrode space
7 electrode
8 sealing ring
9 sealing body
10 receiving socket
11 light-emitting diode
12 light conductor
13 opening
14 screw cap
15 spring
16 sealing ring
17 bow
18 screw
19 screw

1. Rod-shaped electrolysis device (1) having an electrically conductive housing (2), wherein in the housing (2), a receiving space (3) for at least one voltage source (4) and an electronic control unit (5) are embodied, the receiving space (3) being separated from an electrode space (6) formed in the housing (2) in a liquid-tight manner, and an electrode (7) extending within the electrode space (6), and in the housing (2), at least one opening (13) being formed in the region of the electrode space (6),
characterized in that
the housing (2) comprises a receiving socket (10) which is electrically connected both with the housing (2) and with the electrode (7).

2. Rod-shaped electrolysis device (1) according to claim 1,
characterized in that
the receiving socket (10) is arranged at a front face of the housing (2).

3. Rod-shaped electrolysis device (1) according to claim 1,
characterized in that
the electrode (7) is rod-shaped and comprises a hemispherical front face.

4. Rod-shaped electrolysis device (1) according to claim 1,
characterized in that
in the electrode space (6) between the housing (2) and the electrode (7), a sealing body (9) is arranged which extends across a portion of the receiving space (3) and/or the electrode space (6).

5. Rod-shaped electrolysis device (1) according to claim 1,
characterized in that
within the receiving space (3), at least one lamp (11) is arranged and at least one light conductor (12) extends from the receiving space (3) into the electrode space (6), the light conductor (12) being arranged at one end within the receiving space (3) such that the light emitted from the lamp (11) enters the light conductor (12).

6. Rod-shaped electrolysis device (1) according to claim 5,
characterized in that
the lamp (11) is a light-emitting diode and/or the light conductor (12) is at least a glass fibre or at least a glass fibre bundle.

7. Rod-shaped electrolysis device (1) according to claim 5,
characterized in that
the light conductor (12) is guided, at the other end, into the electrode space (6) to the opening (13).

8. Rod-shaped electrolysis device (1) according to claim 5,
characterized in that
the light conductor (12) extends through the sealing body (9).

9. Rod-shaped electrolysis device (1) according to claim 1,
characterized in that
the electronic control unit (5) comprises a time switch, a magnetic field sensor being present and the time switch being activated by an external magnetic field, and/or a motion sensor being provided and the time switch being activated by a shock of the housing (2) detected by the motion sensor.

10. Rod-shaped electrolysis device (1) according to claim 9,
characterized in that
a term as a multiple of a time interval may be determined by repeatedly approaching an external magnetic field to the housing (2) and/or by a repeated shock of the housing (2), the multiple being equal to the number of repetitions.

11. Rod-shaped electrolysis device (1) according to claim 1,
characterized in that
the electronic control unit (5) comprises a current and voltage regulator by means of which the voltage between the housing (2) and the electrode (7) and the intensity of current flowing between them may be adjusted to different values.

12. Rod-shaped electrolysis device (1) according to claim 11,
characterized in that
the current and voltage regulator comprises a switchable MOSFET by means of which the intensity of current between the housing (2) and the electrode (7) may be adjusted.

13. Rod-shaped electrolysis device (1) according to claim 1,
characterized in that,
the electronic control unit (5) comprises a microprocessor which performs a calculation of the conductance and adjusts, depending on the calculated conductance, the voltage and the intensity of current between the housing (2) and the electrode (7).

14. Rod-shaped electrolysis device (1) according to claim 1,
characterized in that,
the electronic control unit (5) comprises a data memory, and the receiving socket (10) is electrically connected to the data memory such that the data memory may be read out via the receiving socket (10), operational data of the electrolysis device (1) being stored in the data memory.

15. Rod-shaped electrolysis device (1) according to claim 1,
characterized in that
the electrolysis device (1) comprises an acoustic signal transmitter.
